(19) United States
(12) Patent Application Publication
(10) Pub. No.: US 2025/0278284 A1
(43) Pub. Date: Sep. 4, 2025

(54) SYSTEM AND METHOD FOR USER-SPECIFIC AND CONTEXT-BASED ICON ASSIGNMENT IN A CONVERSATIONAL INTERFACE

(71) Applicant: CELLIGENCE INTERNATIONAL LLC, Guaynabo, PR (US)

(72) Inventors: Pavan AGARWAL, DORADO, PR (US); Gabriel Albors Sanchez, San Juan, PR (US); Jonathan Oritz Rivera, San JUAN, PR (US)

(73) Assignee: CELLIGENCE INTERNATIONAL LLC, Guaynabo, PR (US)

(21) Appl. No.: 19/212,460

(22) Filed: May 19, 2025

Related U.S. Application Data
(63) Continuation-in-part of application No. 18/135,703, filed on Apr. 17, 2023.
(60) Provisional application No. 63/332,205, filed on Apr. 18, 2022.

(51) Int. Cl. G06F 9/451; G06F 16/535; G06F 16/58; G06F 40/30; H04L 51/18; H04L 51/216

(52) U.S. Cl. CPC G06F 9/451; G06F 16/535; G06F 16/58; G06F 40/30; H04L 51/18; H04L 51/216

(57) ABSTRACT

A system and method for assigning user-specific and context-based icons in a conversational interface. The method includes detecting structured objects in message prompts using a context analysis engine, selecting an icon via a machine learning model or stored user mapping, and rendering the icon across multiple interface regions, including adjacent to the prompt, within the user input field, and—if applicable—next to the user's response. Icon assignment may be personalized per user and updated based on user behavior or operator feedback. If the user response does not satisfy the expected object type, the icon is omitted, signaling a break in conversational continuity. The system improves message clarity, user experience consistency, and domain-aware scalability across structured data collection workflows.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD

The present disclosure relates to conversational AI interfaces, and more specifically to systems and methods for assigning icons based on structured data context and personalizing icon selection using machine learning.

### BACKGROUND

Conversational user interfaces, including chatbots and AI assistants, are increasingly used to collect information from users in domains such as finance, healthcare, and insurance. However, users may become disoriented or overwhelmed by extended conversations, especially when multiple structured data elements are collected across many interaction turns. Visual cues such as icons can reduce cognitive load, but current systems assign static or generic icons without accounting for user context, machine learning feedback, or domain-specific semantics. Moreover, there is often no persistence in icon usage across the conversation, leading to confusion when reviewing previous entries.

### SUMMARY

The present disclosure relates to systems and methods for enhancing conversational user interfaces through the dynamic and context-aware assignment of icons. In particular, the system enables icon rendering based on structured object references detected within system-generated prompts, and maintains visual consistency across the interface to assist with user comprehension, response validation, and data entry reliability.

In some embodiments, the system comprises a conversational application that includes a chat interface engine, a context analysis engine, an icon selection module, a user personalization module, and an icon rendering module. When a message is received that includes a prompt for a structured data object (e.g., loan amount, date of birth), the context analysis engine determines the object type, and the icon selection module identifies an appropriate icon to represent the object.

The icon is rendered within multiple regions of the user interface, including adjacent to the prompt message and within the user's input field. If the user submits a response that satisfies the requested structured object, the same icon is also rendered adjacent to the submitted response. If the response does not satisfy the prompt, the icon is omitted, thereby signaling broken object continuity.

In further embodiments, the system supports user-specific icon mappings, maintained in a user mapping data store. These mappings may be updated over time based on user behavior or operator confirmation, allowing for personalized icon consistency. The icon selection module may also employ a machine learning model trained on prior interactions to rank or disambiguate among candidate icons.

Additionally, domain context (e.g., mortgage vs. personal loan) may influence icon selection for the same structured object, improving semantic clarity across vertical applications. Accessibility features such as screen-reader metadata and alternate icon styles may also be integrated. The system improves conversational clarity, scalability, and trust by reinforcing structured data collection with consistent, personalized, and contextually appropriate visual indicators.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram of an exemplary system architecture for implementing context-based icon assignment within a conversational interface, according to an implementation of the disclosure.

FIG. 2 is a flowchart illustrating a method for evaluating structured object prompts, conditionally rendering icons based on user response accuracy, and maintaining icon continuity across message turns, according to an implementation of the disclosure.

FIG. 3 illustrates an example user interface layout showing how icons are rendered adjacent to system prompts, within user input fields, and alongside validated user responses in a chat thread, according to an implementation of the disclosure.

FIG. 4 illustrates a feedback loop in which user interactions and optional operator input are used to update a machine learning model for future icon selection, according to an implementation of the disclosure.

FIG. 5 illustrates a workflow for retrieving and updating user-specific icon mappings, according to an implementation of the disclosure.

FIG. 6 illustrates a disambiguation flow for ambiguous structured object references, according to an implementation of the disclosure.

FIG. 7 illustrates an example computing system that may be used in implementing various features of embodiments of the disclosed technology.

Described herein are systems and methods for enabling context-based icon assignment within a conversational interface. Rather than relying solely on static UI elements or plain-text prompts, the disclosed system dynamically detects structured objects within messages and renders corresponding icons to enhance user clarity and interaction flow. Icons may be selected based on object type, user-specific mappings, or domain context, and are rendered in multiple regions of the interface, including adjacent to prompts, within user input fields, and—when appropriate-alongside validated user responses. The system further supports omission of icons when user input deviates from expected object types, signaling conversational discontinuity. Icon selection may be refined over time using machine learning models trained on prior interactions and operator feedback. The architecture supports adaptive visual feedback, personalized user experiences, and scalable deployment across diverse domains and structured data collection use cases. The following description sets forth several illustrative embodiments of the disclosed system, including modular architecture, messaging logic, and multi-device support. Other features and advantages will become apparent to those skilled in the art upon review of the specification, drawings, and claims. It is intended that all such systems, methods, features, and enhancements be considered within the scope of the present disclosure and protected by the accompanying claims.

### DETAILED DESCRIPTION

The disclosed system comprises a backend computing server in communication with one or more client computing devices configured to facilitate dynamic icon assignment within a conversational interface. The system analyzes incoming and outgoing chat messages to detect structured data requests and intelligently assigns contextually appropriate icons to enhance user comprehension. These icons are rendered alongside the system prompt, user input field, and user response-creating a persistent visual thread throughout the interaction. The system further supports user-specific icon customization and machine learning-based icon selection, streamlining data collection workflows and reducing ambiguity during extended chat sessions.

Conventional messaging systems typically display conversational text without visual differentiation of structured data elements, relying entirely on natural language for context. These systems do not utilize icons to visually reinforce the meaning or intent of a given message, nor do they track or persist icon usage across related turns in the conversation. As a result, users may experience confusion when reviewing prior messages, especially in scenarios involving complex transactions or repeated object references (e.g., loan amounts, identification numbers).

Furthermore, existing systems lack the ability to assign icons based on individual user profiles or prior interactions, offering only generic or hardcoded icon mappings-if any are used at all. They also fail to leverage machine learning models to refine icon selection over time or adapt to variations in user phrasing. Current implementations do not distinguish between valid and invalid user responses in a way that visually signals conversational breakdown (e.g., omitting the icon when a response does not match the requested object). As such, no known system provides a seamless, AI-powered solution for dynamically assigning, personalizing, and maintaining icons in contextually intelligent chat interfaces.

The disclosed system improves the functionality of conversational user interfaces by integrating dynamic, context-based iconography that enhances semantic clarity, data accuracy, and visual coherence. Unlike conventional systems that merely process user messages as undifferentiated text, the present system identifies structured data objects (e.g., loan amounts, social security numbers, or birthdates) in real time and pairs them with visually meaningful icons. This icon-object association is applied consistently across system prompts, user input fields, and confirmed user responses, enabling users to intuitively track key data elements throughout a conversation.

In contrast to hardcoded or static icon implementations, the disclosed system uses machine learning techniques to select and adapt icon assignments based on historical usage patterns, keyword embeddings, and user-specific feedback. This enables the system to learn how different users refer to the same object across different domains and conversational contexts. The ability to adapt icon presentation per user and update associations over time reflects a technological improvement in the underlying UI logic and interaction model-enhancing both scalability and personalization in large-scale deployments.

Additionally, the system offers a novel visual signaling mechanism to indicate conversational breakdowns. If a user provides a response that does not correspond to the requested structured object (e.g., responding “I'm not sure” when asked for a loan amount), the icon is deliberately withheld. This visual omission serves as a lightweight but effective cue to both users and downstream systems that the expected data was not collected. Such a mechanism improves error recovery workflows, reduces misinterpretation of ambiguous responses, and enhances overall system robustness in real-time, multi-turn conversational environments.

The disclosed system includes several key components and modules that collectively enable context-based icon assignment within a conversational interface. These components may be deployed on a client device (e.g., smartphone, tablet, desktop) and/or operate in coordination with a backend computing server to facilitate real-time message analysis, icon selection, and user-specific customization. The system may be implemented as part of a standalone chat application or embedded within a broader conversational interface platform, and is designed to operate seamlessly across both mobile and desktop environments.

The system architecture comprises a modular framework including at least the following components: (i) a Chat Interface Engine, (ii) an Icon Selection Module, (iii) a User Personalization Module, (iv) a Context Analysis Engine, and (v) a Rendering Module. These modules may operate cooperatively across distributed environments and are designed to enable scalable, real-time integration of icon-enhanced messaging workflows.

The Chat Interface Engine serves as the primary interface for managing bi-directional communication between the user and the AI assistant. It is responsible for parsing incoming prompts, handling user inputs, and coordinating message delivery. As part of this role, the engine interfaces with the Context Analysis Engine to determine whether a message includes a structured data request that qualifies for icon annotation. It also ensures persistent application of previously selected icons for recurring object references throughout the conversation.

The Icon Selection Module includes a keyword-to-icon matching engine, a semantic similarity model (e.g., using vector embeddings), and optionally a machine learning classifier trained on labeled object-icon pairs. This module is responsible for retrieving candidate icons from an icon database and ranking them based on contextual relevance, prior operator selections, and historical user interactions. When confidence thresholds are met, the module may assign icons autonomously; otherwise, an operator approval loop may be triggered to reinforce model learning.

The User Personalization Module maintains per-user icon-object mappings that evolve over time based on user interactions and confirmed assignments. This allows the same structured object (e.g., “loan amount”) to be represented by different icons for different users, depending on personal preferences, prior usage patterns, or domain-specific semantics. The Rendering Module coordinates with the chat interface to display selected icons in designated regions of the interface-typically to the right of system prompts, to the left of input fields, and alongside user-submitted responses when the input satisfies the structured request.

The Context Analysis Engine uses natural language processing (NLP) techniques to extract structured data requests from free-text messages. It may leverage named entity recognition, part-of-speech tagging, dependency parsing, or transformer-based sequence models to identify conversational intent and object references, including semantically equivalent variants (e.g., “loan balance,” “note amount,” “how much do I qualify for”). It also determines whether a user response satisfies the expected object type or deviates from the requested input-informing whether the icon should be rendered or withheld.

The Rendering Module governs how icons are visually incorporated into the chat interface. When a structured object is detected and an icon is selected, the Rendering Module places the icon in multiple regions of the chat UI to create a visually coherent trail: (i) adjacent to the inbound request message, (ii) within the user input field, and (iii) alongside the user's response-if the response matches the expected object. If the response is determined to be off-topic or non-responsive, the icon is intentionally omitted to signal a break in continuity.

The disclosed system delivers several core functionalities that distinguish it from conventional conversational interfaces and enhance structured data interactions with real-time visual reinforcement.

Upon detection of a structured object in a message (e.g., loan amount, birthdate, SSN), the system dynamically assigns a relevant icon using a combination of semantic analysis, historical usage data, and machine learning ranking.

Once an icon is selected for a given object, the system maintains that icon throughout the conversation thread, ensuring that subsequent references to the same object reuse the same visual symbol to promote continuity and user recognition.

The system supports individualized icon-object associations on a per-user basis. These mappings evolve over time, allowing different users to encounter tailored visualizations that align with their interaction history and domain preferences.

Before rendering an icon alongside a user's response, the system evaluates whether the response satisfies the object that was originally requested. If the input does not match the expected object (e.g., is ambiguous or off-topic), the icon is omitted to signal that structured data was not successfully collected.

Icons are rendered at three primary locations within the chat interface: (i) adjacent to the system's structured data request, (ii) within the user input field as a visual prompt, and (iii) alongside the user's response when appropriate. This coordinated placement reinforces meaning across the interaction.

The system refines icon selection over time using a feedback loop informed by human operator approvals, frequency of successful icon-object pairings, and contextual success in matching user inputs to structured fields. This enables both global and user-specific model improvement.

The disclosed system provides several notable advantages over conventional conversational interfaces, particularly in the context of structured data collection, user personalization, and semantic clarity.

Visual consistency enhances readability and reduces user error. By persistently applying the same icon to repeated references of the same structured object, users are better able to track important data points across multi-turn conversations. This visual reinforcement reduces the risk of misreading or overlooking key information, especially in long or complex chat threads.

User-specific icons personalize the experience. The system's ability to maintain per-user icon mappings ensures that users encounter visual cues that are familiar and contextually appropriate. This personalization increases comfort, recognition speed, and engagement-particularly in high-stakes domains like finance or healthcare.

ML-driven icon selection enables scalability across domains and object variants. By using machine learning to dynamically select and refine icon assignments, the system can handle an expansive and evolving set of structured objects, even when phrased differently by different users. This supports deployment across multiple industries and product types without requiring manual hardcoding for each use case.

Icon omission provides intuitive error signaling. When a user fails to respond with the expected object type (e.g., answering “I'm not sure” instead of providing a loan amount), the deliberate omission of the icon signals a break in the expected data flow. This subtle but effective feedback mechanism improves the system's ability to detect incomplete or invalid inputs and supports more efficient error recovery.

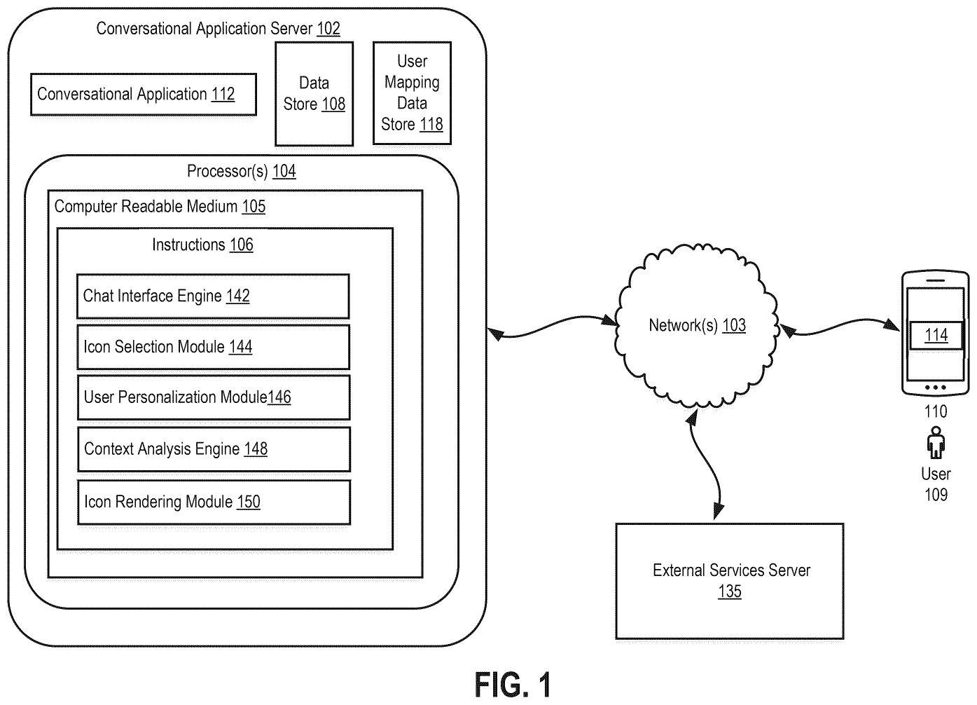

FIG. 1 illustrates an example system architecture for implementing context-based icon assignment within a conversational interface. The system includes modules for structured object detection, icon selection, user-specific mapping, and icon rendering. These modules collectively enable dynamic, personalized, and persistent icon placement alongside chat messages. The system includes a conversational application server 102, a client computing device 110, and optionally one or more external services servers 135, all interconnected via a network 103 (e.g., the Internet, a mobile network, or a secure enterprise network).

In the exemplary icon-enabled conversational system 100, a user 109 engages with the conversational application server 102 using a client computing device 110 over one or more networks 103. The interaction may occur via a web-based chat interface, native mobile app, or embedded messaging component. Unlike conventional systems that merely display raw text, the present system enhances message clarity and data tracking by assigning structured object-specific icons that persist across the conversation. The conversational application server 102 executes a conversational application 112, using one or more processors 104 to execute instructions 106 stored in a computer-readable medium 105. These instructions include modules that analyze message content, determine object context, select and assign appropriate icons, and manage rendering based on user-specific profiles and message relevance.

The conversational application server 102 hosts the core backend logic for managing icon-enhanced conversational workflows. It includes one or more processors 104, a computer-readable medium 105 storing instructions 106, and one or more data stores including a general-purpose data store 108 and a user mapping data store 118 for persisting icon-object associations and user-specific mappings. The server executes a conversational application 112, which includes various functional modules such as a chat interface engine 142, an icon selection module 144, a user personalization module 146, a context analysis engine 148, and an Icon rendering module 150. These modules collectively enable detection of structured object references, dynamic icon selection, per-user customization, and multi-point rendering of icons throughout the conversational interface.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The instructions 106 include various functional modules that enable context-based icon detection, selection, personalization, and rendering within a conversational interface. These modules include a chat interface engine 142, configured to parse incoming messages and determine whether they include structured data requests; an Icon selection module 144, which retrieves candidate icons from a database and ranks them using contextual and semantic signals; a context analysis engine 148, which applies natural language processing to identify structured objects (e.g., “loan amount,” “birth date”) within user or system messages; a user personalization module 146, which maintains per-user icon-object associations and updates them based on usage history; and an Icon rendering module 150, which governs the placement of selected icons within the chat interface-such as beside system prompts, inside input fields, and next to user-submitted responses when applicable.

Chat interface engine 142 coordinates message parsing, conversational state management, and structured object detection. Upon receiving an inbound message from the system or a response from the user, the chat interface engine 142 analyzes the text content in conjunction with context analysis engine 148 to determine whether it references a structured data object (e.g., loan amount, social security number). If a structured object is identified, the chat interface engine 142 initiates a pipeline involving icon selection and rendering. The engine also ensures that icons are applied consistently across message turns referencing the same object.

Icon selection module 144 retrieves and ranks candidate icons from an icon database based on object identity, user history, and contextual keywords. This module may include a semantic similarity model (e.g., embedding-based ranking) and a machine learning classifier trained to select icons based on labeled conversation data. In some cases, operator feedback is used to reinforce or override automated assignments. The selected icon is passed to the Icon rendering module 150 for visual application.

To support persistence and retrieval of individualized icon associations, the system includes a user mapping data store 118, operatively connected to the conversational application 112. This data store maintains structured records linking users to specific icon-object mappings, including metadata such as domain context, prior assignment frequency, and timestamped selection history. The user personalization module 146 reads from and writes to the user mapping data store 118 to ensure that icon behavior reflects each user's prior interactions. For example, when a returning user is prompted for a “loan amount,” the system retrieves the previously selected icon from the user mapping data store 118 and applies it consistently throughout the new conversation. This approach supports long-term personalization across sessions and devices, while also enabling centralized learning models to incorporate aggregated user-icon behavior.

Client computing device 110 may be any suitable computing device such as a smartphone, tablet, or desktop computer. It hosts a chat user interface 114 that displays system messages, input fields, and user responses. The UI integrates icons in the following positions: (i) adjacent to the system's request message, (ii) embedded in the user's input field prior to submission, and (iii) next to the user's response if the system determines it matches the requested structured object. The client device may communicate with external services servers 135, which provide additional resources such as third-party icon sets, language models, or identity verification tools, depending on implementation requirements.

The conversational interface enables the user to communicate naturally using typed input, while the system enhances message clarity and data tracking through real-time icon augmentation. As users engage in chat-based conversations, the system dynamically analyzes incoming and outgoing messages for structured object references and renders visual icons that correspond to the identified objects. This icon-enhanced messaging experience is enabled by the Icon rendering module 150 and occurs seamlessly within the flow of conversation, without requiring separate input modes, pop-ups, or interruptions.

A conversational AI assistant (AA), hosted on the conversational application server 102, guides the user throughout the interaction. The assistant analyzes the message content in real time, classifies structured object types, and interacts with the Icon selection module 144 and Context analysis engine 148 to determine when and how to render icons. It also draws from conversation history and user-specific mappings to ensure consistency and relevance in icon assignment, thereby personalizing the chat experience over time.

The assistant operates independently of any installed mobile or desktop application and may be accessed via browser-based chat, embedded interfaces, or third-party messaging environments. This flexible deployment model enables icon-enhanced messaging to be delivered across devices and platforms without requiring additional software. The assistant's behavior and icon-rendering logic adapt fluidly to the interface environment, maintaining a lightweight, responsive user experience that supports persistent visual reinforcement of structured data throughout the conversation. This flexible deployment model enables icon-enhanced messaging to be delivered across devices and platforms without requiring additional software. User-specific mappings retrieved from the user mapping data store 118 ensure continuity of icon behavior regardless of access point.

In some embodiments, the conversational AI assistant is provided by the conversational application 112, executed on server 102. The assistant interacts with users via natural-language messages and dynamically adjusts icon behavior based on detected object context, user phrasing, and prior icon assignments. It supports workflows such as icon-based data annotation, user-specific icon mapping, and conversational consistency across multiple turns of interaction.

The assistant may be implemented as either an integrated or third-party component running server-side. It processes user messages in real time, coordinates with the Context analysis engine 148 to identify structured objects, and interfaces with the Icon selection module 144 to determine the appropriate icon. Because the assistant operates remotely, it does not require specialized software on the client device-making icon-augmented messaging accessible through standard browser or embedded chat environments.

The assistant continuously evaluates conversational flow to maintain semantic alignment between user input and system expectations. In some implementations, if user input deviates from the expected object (e.g., “I'm not sure” instead of a loan amount), the assistant may withhold icon rendering and optionally trigger a clarification prompt. This behavior enhances data reliability while providing intuitive, visual feedback to the user.

In further embodiments, the system may support multimodal interaction, such as combining typed input with voice-to-text or on-screen selection. Icons may be dynamically adjusted for accessibility purposes (e.g., high contrast, alt text for screen readers), and the assistant may audibly confirm icon-linked data collection actions where appropriate.

In some implementations, the assistant monitors for conversational anomalies related to icon usage. For example, if a user repeatedly provides responses that do not match expected structured objects-resulting in icon omission—or if the system detects inconsistencies in icon-object associations, it may trigger an escalation protocol. In such cases, the assistant may alert a human assistant (HA) and provide metadata including the requested objects, candidate icons, rejected mappings, and user responses. This enables the HA to seamlessly re-engage with the user and resolve the issue with full visibility into the conversation's icon history and semantic context, optionally referencing records stored in the user mapping data store 118.

When a user's message ambiguously refers to multiple potential structured objects-such as “I want to lower my payments,” which could imply a loan amount, loan term, or interest rate—the assistant may initiate a disambiguation sequence. This may include presenting multiple icon options for user confirmation, adjusting the phrasing of the system's follow-up prompt, or selecting a default icon with lower confidence and marking it for future override. In some embodiments, the assistant logs such ambiguous cases for retraining the machine learning model used in the Icon selection module 144, thereby improving future confidence scores and selection accuracy.

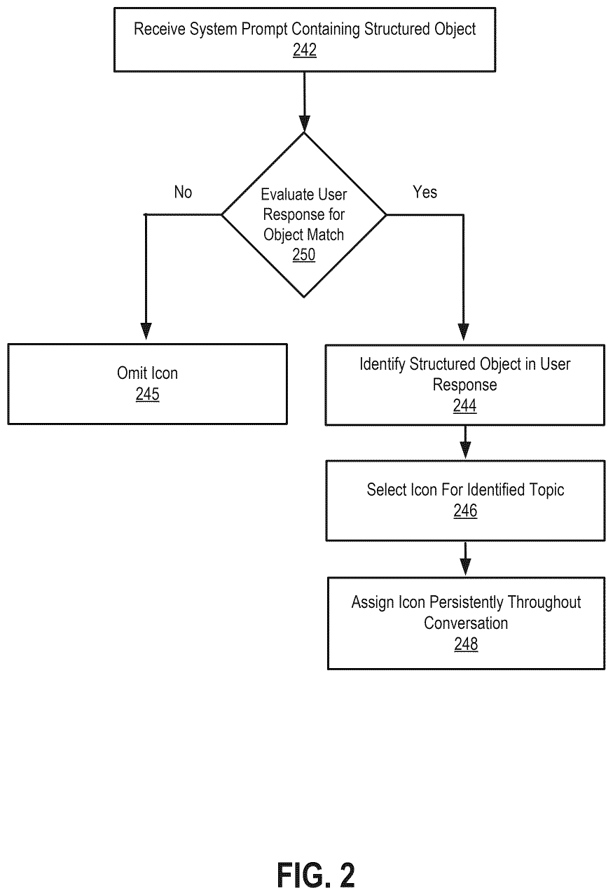

FIG. 2 illustrates an example method for context-based icon assignment and conditional rendering within a conversational interface. The method begins when the system, via the chat interface engine 142, sends a system prompt to the user containing a request for a structured object at step 242. The user's response is then evaluated by the context analysis engine 148 to determine whether it satisfies the requested object type at step 250. If the system determines that the user's response does not match the expected object, for example, if the response is ambiguous or irrelevant, then the icon is omitted from the rendered message at step 245, and no further icon-related actions are taken for that turn.

If the user's response is deemed valid, the system proceeds to parse and identify the structured object using the context analysis engine 148 at step 244, and then selects an appropriate icon for the object using the icon selection module 144 at step 246. Once selected, the icon is assigned persistently across the interface using the icon rendering module 150, which places the icon adjacent to the system prompt, within the user input field, and next to the validated user response at step 248. These operations enable visual continuity and semantic clarity throughout the conversation.

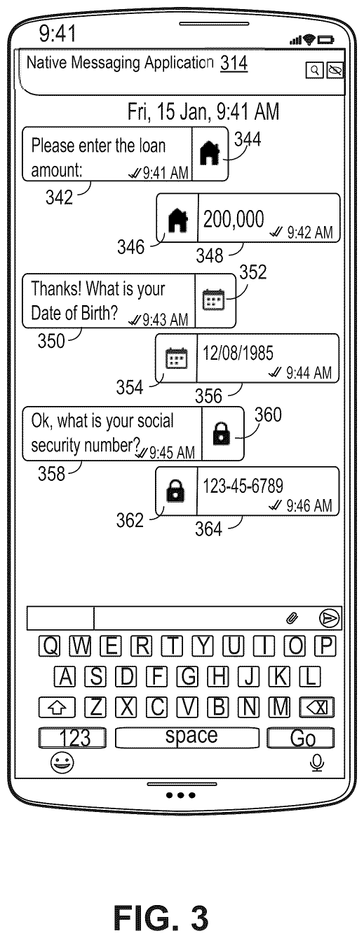

FIG. 3 illustrates an example user interface layout for icon-enhanced messaging within a native messaging application 314. The interface is shown on a client computing device and includes a chat thread in which a conversational AI assistant sequentially requests structured data from the user. At step 342, the assistant prompts the user for a loan amount. In response, the system identifies the structured object and renders an icon 344 (e.g., a house) next to the prompt. The same icon appears within the input region 346 and is displayed again alongside the user's valid response “200,000” (bubble 348).

The interaction continues with subsequent requests for the user's date of birth 350 and social security number 358, each with their own object-specific icons-calendar icon 352 for date of birth, and lock icon 360 for SSN. These icons are rendered consistently across the interface: to the right of the system prompt 352, 360, inside the input field before typing 354, 362, and next to the confirmed user inputs 356, 364. This visual consistency reinforces structured object context across the conversation thread and supports icon persistence logic as described with reference to FIGS. 1 and 2.

In some embodiments, the user interface shown in FIG. 3 may further support accessibility overlays that enhance the usability of icon-enhanced messaging for users with visual impairments or cognitive differences. For example, each icon (e.g., 344, 352, 360) may include metadata such as alternative text labels (“Loan Amount,” “Date of Birth,” “Social Security Number”) that can be read aloud by screen readers or displayed in high-contrast tooltips. The input field regions 346, 354, 362 may also support dynamic enlargement or tactile feedback when icon-linked data is detected. Additionally, the rendering engine may select icon variants from an accessibility-optimized icon set (e.g., simplified silhouettes, bolder outlines) in response to device-level accessibility preferences or user profile data stored in the user mapping data store 118. These enhancements ensure that the system's visual reinforcement mechanisms remain effective across diverse user populations and usage contexts.

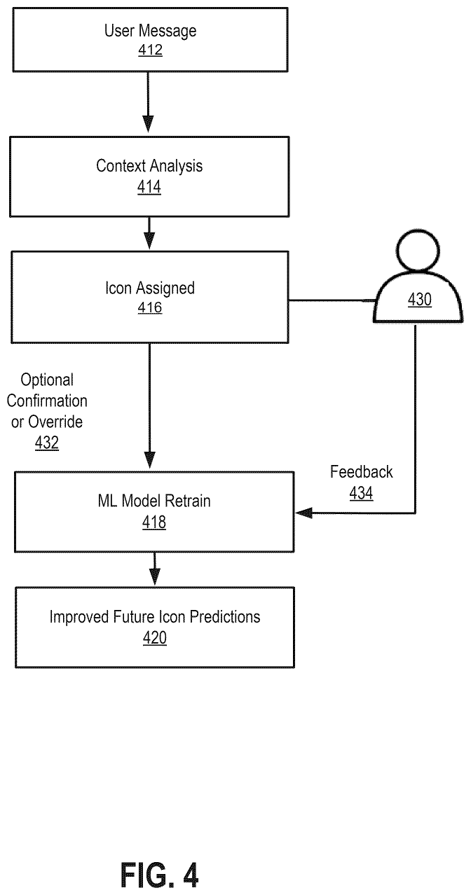

FIG. 4 illustrates an example machine learning feedback loop for refining icon selection based on conversational interactions and optional human supervision. At step 412, a user submits a message containing a potential structured object. The message undergoes contextual parsing by the context analysis engine 148 at step 414, after which the system assigns an icon based on initial predictions from the icon selection module 144 at step 416.

In some embodiments, an operator 430 may review the assigned icon and provide optional confirmation or override input 432. This supervisory feedback is captured and routed to a retraining mechanism within the icon selection module 144, where the model is updated at step 418 based on confirmed icon-object associations and false positive patterns. The retrained model supports improved future icon predictions at step 420 by adjusting ranking weights, refining keyword embeddings, or updating feature correlations within the classifier. Feedback 434 from both user and operator behavior may be aggregated across sessions to support continual model improvement. This adaptive loop enables the system to personalize icon assignment and improve its semantic accuracy over time without requiring rule-based hardcoding.

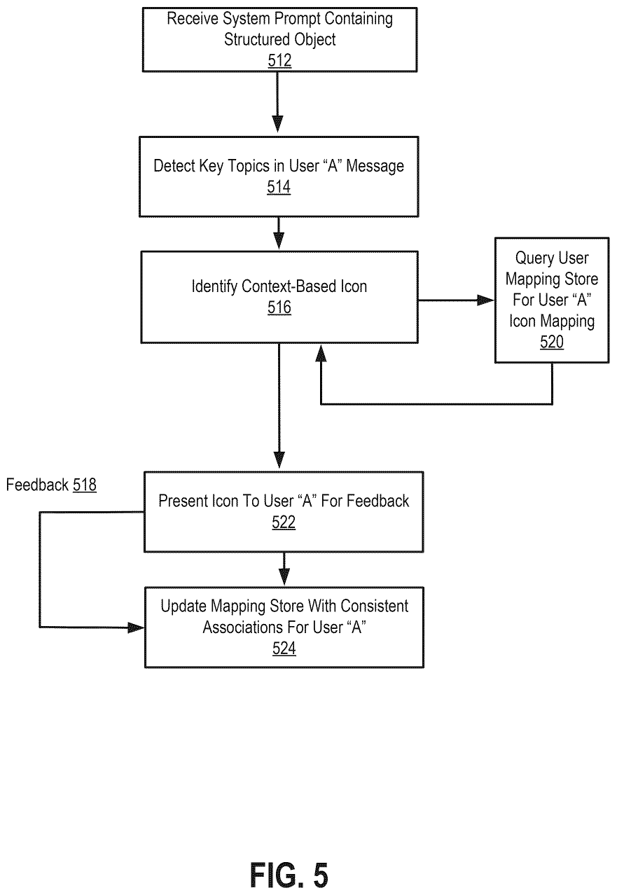

FIG. 5 illustrates an example process for identifying and updating a user-specific icon mapping in response to a structured object prompt. At step 512, the system sends a prompt to user “A” requesting a structured object (e.g., loan amount). The context analysis engine 148 detects key topics within user A's message at step 514 and triggers a context-based icon selection process at step 516. In parallel, the system queries the user mapping data store 118 to determine whether a prior icon mapping exists for user A and the identified object at step 520. If such a mapping exists, the stored icon may be reused; otherwise, the icon selection module 144 proposes a new icon.

The proposed icon is then presented to user A at step 522, either by rendering it adjacent to the input field or through an explicit confirmation UI. Based on this user interaction-whether inferred from continued use or explicitly confirmed—the user personalization module 146 updates the user mapping data store 118 at step 524 to strengthen or revise the icon-object association. The feedback path 518 ensures that consistent icon behavior is reinforced over time, enabling long-term personalization that adapts to each user's domain familiarity, icon preferences, and conversational patterns.

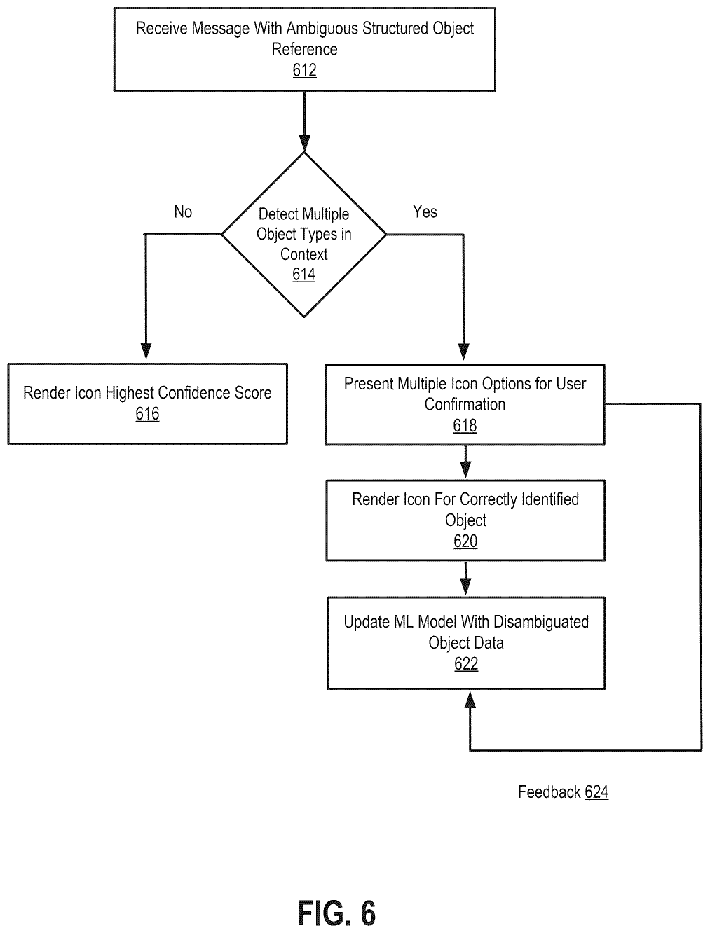

FIG. 6 illustrates a disambiguation workflow for resolving ambiguous structured object references within a conversational interface. At step 612, the system receives a user message that potentially references a structured object but contains insufficient specificity (e.g., “I want to reduce my payment” could imply loan amount, interest rate, or loan term). At decision step 614, the Context Analysis Engine 148 evaluates the surrounding context to determine whether multiple object types are plausible.

If only one candidate object is detected, the system proceeds to render the icon associated with the highest confidence score at step 616, as determined by the icon selection module 144. If multiple candidate objects are identified, the system presents several icon options for user confirmation at step 618, either as inline prompts or UI overlays. Once the user selects or otherwise confirms the correct object, the corresponding icon is rendered at step 620 via the icon rendering module 150.

Subsequently, the disambiguated object data is used to update the underlying machine learning model at step 622, refining future prediction weights and improving confidence scoring. Feedback path 624 ensures that this user interaction contributes to long-term model learning, particularly for edge cases or ambiguous phrasing patterns.

In some embodiments, icon selection may further be conditioned on the detected domain context of the conversation. For example, the structured object “loan amount” may appear across multiple financial domains but carry different semantic or visual associations. In the context of a mortgage transaction, the system may associate “loan amount” with a house-related icon, whereas in the context of a personal loan, the same object may be represented with a currency-related icon. The icon selection module 144 may take as input a domain identifier-either explicitly supplied via metadata or inferred using conversational cues by the context analysis engine 148, and select the most contextually appropriate icon accordingly.

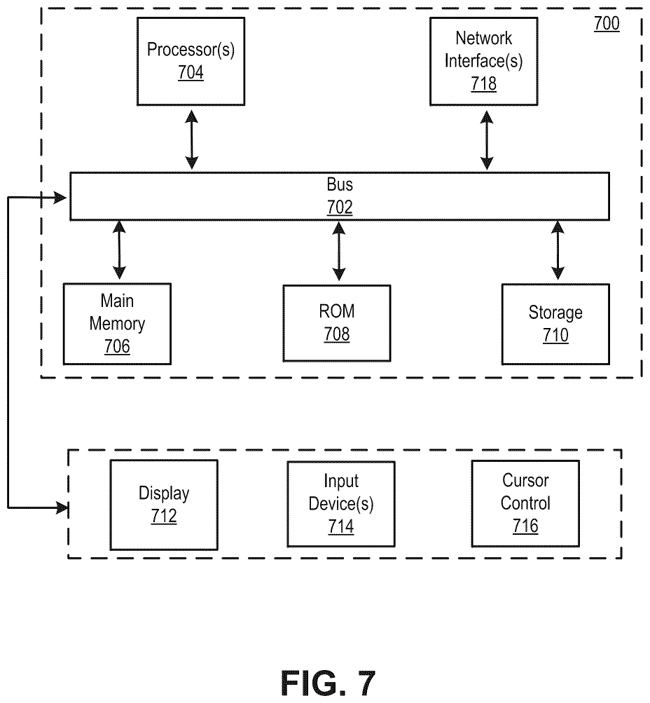

Domain-specific mappings may be stored alongside object definitions in a centralized repository or derived from learned user behavior across similar transaction types. In some implementations, the user mapping data store 118 may maintain separate icon-object associations per domain, enabling a single user to see different icons for the same field depending on the context of use. This layered approach improves semantic accuracy, reduces user confusion, and enhances the adaptability of the system across enterprise applications.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 7. Various embodiments are described in terms of this example computing module 700. After reading this description, it will become apparent to a person skilled in the relevant art how to implement the technology using other logical circuits or architectures.

FIG. 7 illustrates an example computing module 700, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally. The bus 702 may also be connected to other components such as a display 712, input devices 55, or cursor control 716 to help facilitate interaction and communications between the processor and/or other components of the computing module 700.

Computing module 700 might also include one or more memory modules, simply referred to herein as main memory 706. For example, preferably random-access memory (RAM) or other dynamic memory might be used for storing information and instructions to be executed by processor 704. Main memory 706 might also be used for storing temporary variables or other intermediate information during execution of instructions to be executed by processor 704. Computing module 700 might likewise include a read only memory (“ROM”) 708 or other static storage device 710 coupled to bus 702 for storing static information and instructions for processor 704.

Computing module 700 might also include one or more various forms of information storage devices 710, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 710 might include other similar instrumentalities for allowing computer programs or other instructions or data to be loaded into computing module 700. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 700. Computing module 700 might also include a communications interface or

network interface(s) 718. Communications or network interface(s) interface 718 might be used to allow software and data to be transferred between computing module 700 and external devices. Examples of communications interface or network interface(s) 718 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 718 might typically be carried on signals, which can be electronic, electromagnetic (which includes optical) or other signals capable of being exchanged by a given communications interface. These signals might be provided to communications interface 718 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 706, ROM 708, and storage unit interface 710. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for dynamically assigning icons within a conversational user interface based on structured data context, the method comprising:
receiving, by a computing system, a message within a conversational thread, the message comprising a prompt that requests a structured object;
analyzing the message using a context analysis engine to determine an object type referenced in the message;
determining, using an icon selection module, an icon corresponding to the object type;
rendering the icon in at least two user interface regions, wherein a first user interface region is adjacent to the prompt message, and wherein a second user interface region is within a user input field associated with the prompt;
receiving a user response to the prompt;
evaluating whether the user response satisfies the structured object type; and
conditionally rendering the icon adjacent to the user response based on whether the response satisfies the structured object type.

2. The method of claim 1, further comprising omitting the icon from rendering adjacent to the user response in response to determining that the user response does not satisfy the structured object type.

3. The method of claim 1, wherein the icon is selected based at least in part on a prior user-specific mapping retrieved from a user mapping data store.

4. The method of claim 3, further comprising updating the user mapping data store based on confirmation or inferred feedback associated with the rendered icon.

5. The method of claim 1, wherein determining the icon comprises ranking a plurality of candidate icons using a machine learning model trained on prior structured object interactions.

6. The method of claim 1, wherein selecting the icon is further based on a detected domain context associated with the conversation.

7. The method of claim 6, wherein the domain context is determined by analyzing prior conversational messages or system metadata.

8. The method of claim 1, wherein the icon comprises accessibility metadata for use by a screen reader, magnifier, or alternative display modality.

9. A system for dynamic icon rendering in a conversational user interface, comprising:
a chat interface engine configured to manage a conversational thread comprising prompt messages and user responses;
a context analysis engine configured to analyze a prompt message to determine a structured object type;
an icon selection module configured to determine an icon corresponding to the structured object type;
an icon rendering module configured to:
render the icon in at least two user interface regions, wherein a first user interface region is adjacent to the prompt message, and wherein a second user interface region is within a user input field associated with the prompt; and
render the icon adjacent to a user response in response to determining that the response satisfies the structured object type;
a response evaluation module configured to determine whether the user response satisfies the structured object type; and
a user personalization module and a user mapping data store configured to store and update user-specific icon-object associations.

10. The system of claim 9, wherein the icon rendering module is further configured to omit the icon adjacent to the user response in response to the response not satisfying the structured object type.

11. The system of claim 9, wherein the icon selection module selects the icon based at least in part on a user-specific icon-object mapping retrieved from the user mapping data store.

12. The system of claim 11, wherein the user personalization module is further configured to update the user mapping data store based on user confirmation, user behavior, or feedback associated with the rendered icon.

13. The system of claim 9, wherein the icon selection module comprises a machine learning model trained on prior structured object interactions to rank multiple candidate icons.

14. The system of claim 9, wherein the icon selection module determines the icon based at least in part on a domain context associated with the conversation.

15. The system of claim 14, wherein the domain context is determined by the context analysis engine based on one or more of: conversational message history, user metadata, and associated transaction type.

16. The system of claim 9, wherein the icon rendering module is further configured to associate accessibility metadata with the rendered icon, the metadata being compatible with screen readers, magnifiers, or alternate display modalities.
